(19) United States
(12) Patent Application Publication
(10) Pub. No.: US 2005/0162620 A1
(43) Pub. Date: Jul. 28, 2005

(54) Image processing apparatus

(75) Inventors: Hiroyuki Taguchi, Isesaki (JP); Nobuhiko Omori, Ora-Gun (JP); Kouichiro Yanagi, Himeji (JP)

Correspondence Address: OSHA LIANG L.L.P., 1221 MCKINNEY STREET, SUITE 2800, HOUSTON, TX, 77010, US

(73) Assignee: Sanyo Electric Co., Ltd., Osaka (JP)

(21) Appl. No.: 11/038,346

(22) Filed: Jan. 19, 2005

(30) Foreign Application Priority Data
Jan. 22, 2004 (JP) JP2004-14833

(51) Int. Cl. G03B 21/14

(52) U.S. Cl. 353/69

(57) ABSTRACT

An image processing apparatus used in a projection display device which displays an image formed on an image forming section by projecting it on a screen, for correcting the original image in order to correct a trapezoid distortion produced when the image is projected obliquely on the screen and forming the image to be formed on the image forming section, comprising a trapezoid correction section for correcting the trapezoid distortion by reducing the original image by pixel interpolation for producing one pixel from plural pixels; and an outline correction section for performing an edge emphasis processing on the distortion corrected image obtained by the trapezoid correction section.

### CROSS-REFERENCE TO RELATED APPLICATION

The entire disclosure of Japanese Application No. 2004-014833 including the specification, claims, drawings and abstract is incorporated herein by reference.

### BACKGROUND OF THE INVENTION

1. Field of the Invention

The present invention relates to an image processing apparatus used in a projection display device which displays an image formed on an image forming section by projecting it on a screen, in which the image processing apparatus corrects the original image in order to correct a trapezoid distortion, which is caused when the image is projected obliquely on the screen, and creates the image to be formed on the image forming section.

2. Description of the Related Art

Projection display devices which magnify and project an image shown on a display device onto a screen are well known. One example of such a projection display device is configured using a liquid crystal projector which displays a large screen by magnifying and projecting an image shown on a small liquid crystal panel through a lens. As shown in FIG. 11, in such a system, a liquid crystal projector 200 is generally disposed either lower or higher than a screen S so that the liquid crystal projector 200 does not block the view of the screen S. As such, the image shown on the liquid crystal panel is projected obliquely onto the screen S. When the image is projected upward as shown in FIG. 11, an optical path length becomes long and a magnification ratio becomes large as the projection becomes closer to the top portion. Therefore, when a rectangular original image is shown as it is on the liquid crystal panel, a projection image A projected on the screen S has a trapezoidal shape wider at the top, as shown in FIG. 12. This is commonly referred to as “trapezoid distortion” or “keystone distortion”. Therefore, the original image is generally subjected to trapezoid correction (also known as keystone correction) so that the projected image becomes similar to the original image (projection image B of FIG. 12). Specifically, the original image is reduced to form a corrected image having a trapezoid shape reverse to the projection image A, and the corrected image is displayed on the liquid crystal panel.

Here, the liquid crystal panel has pixels arrayed in a matrix, the original image and the corrected image are expressed as data for pixel values arrayed in a matrix. Therefore, the original image is reduced to the corrected image by decreasing the number of effective pixels. However, if the pixels are simply thinned out to decrease the number of effective pixels, data is lost, and the image becomes rough. Therefore, to obtain a smooth image, various image interpolation algorithms are often used to determine the pixel value after the reduction from the plural pixel values of the original image.

However, because edges become dull when the image is reduced by the pixel interpolation for forming one pixel from a plurality of pixels, when the above-described trapezoid correction is performed, the edges in the resulting image are blurred.

### SUMMARY OF THE INVENTION

The present invention is an image processing apparatus used in a projection display device which displays an image formed on an image forming section by projecting it on a screen, for correcting the original image to correct a trapezoid distortion produced when the image is projected obliquely on the screen and forming the image to be formed on the image forming section comprises a trapezoid correction section for correcting the trapezoid distortion by reducing the original image by pixel interpolation for producing one pixel from plural pixels; and an outline correction section for performing an edge emphasis processing on the distortion corrected image obtained by the trapezoid correction section.

### BRIEF DESCRIPTION OF THE DRAWINGS

A preferred embodiment of the present invention will be described in further detail based on the following drawings, wherein:

FIG. 1 is a block diagram showing the structure of a liquid crystal projector including an image processing apparatus according to this embodiment;

FIG. 2 is a block diagram showing the structure of the image processing apparatus;

FIG. 3 is a view showing a projected state observed from a horizontal direction;

FIG. 4 is a view showing an array of pixels of the original image;

FIG. 5 is a view showing an array of pixels of a distortion corrected image;

FIG. 6 is a view showing a reduction processing in a vertical direction;

FIG. 7 is a view showing a reduction processing in a horizontal direction;

FIG. 8 is a view illustrating the concept of an average pixel method;

FIG. 9 is a block diagram showing an example structure of an outline correction section;

FIG. 10 is a flowchart showing the operation procedure of an image processing apparatus;

FIG. 11 is a view showing a liquid crystal projector and a screen observed from a horizontal direction; and

FIG. 12 is a view showing a projection image projected on a screen.

### DESCRIPTION OF THE PREFERRED EMBODIMENT

A preferred embodiment of the present invention will be described with reference to the drawings.

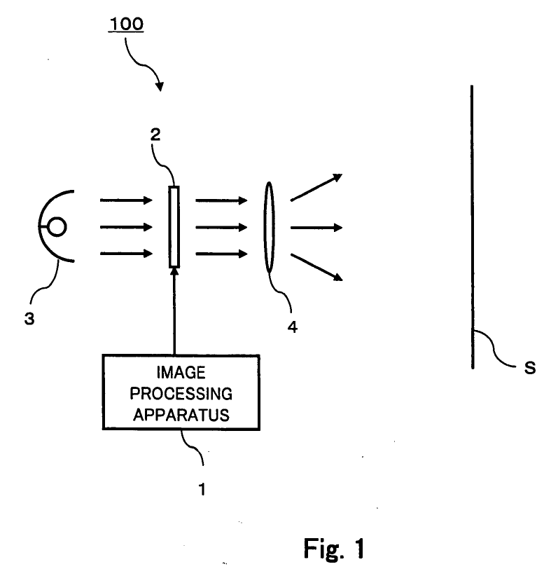

FIG. 1 is a block diagram showing the structure of a liquid crystal projector 100 including an image processing apparatus 1 according to this embodiment. This liquid crystal projector 100 forms an image to be projected on a screen S on a liquid crystal panel 2 which is an image forming section. A light source 3 emits light from the back of the liquid crystal panel 2. The light having passed through the liquid crystal panel 2 is magnified and projected on the screen S by a projection lens 4.

When a normal line of the screen S and the optical axis of the projection lens 4 are displaced, a trapezoid distortion is generated. Therefore, the liquid crystal projector 100 is provided with the image processing apparatus 1 to perform a trapezoid correction processing.

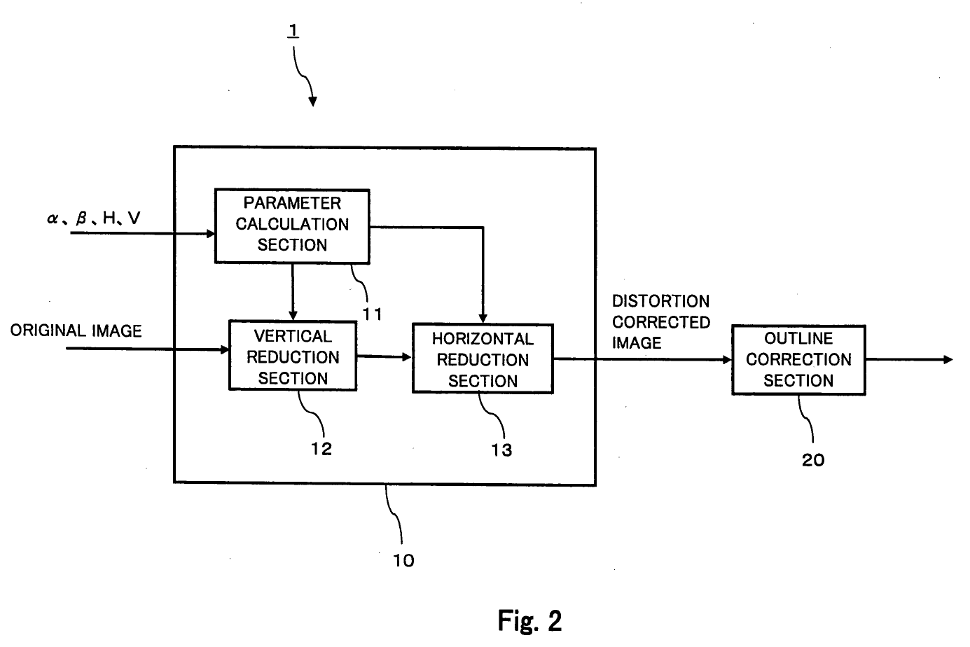

FIG. 2 is a block diagram showing the structure of the image processing apparatus 1. The image processing apparatus 1 performs trapezoid correction on the input original image and gives the corrected image to the liquid crystal panel 2. The image processing apparatus 1 has a trapezoid correction section 10 and an outline correction section 20. Here, both the correction sections 10, 20 may be realized by a hardware circuit or may be realized by a CPU and a RAM which execute a program stored on a recording medium such as a ROM.

The trapezoid correction section 10 performs a reduction processing on the original image to correct the trapezoid distortion. This trapezoid correction section 10 has a parameter calculation section 11, a vertical reduction section 12 and a horizontal reduction section 13. In this specification, the height direction of the image is called as the vertical direction and the breadth direction of the image is called as the horizontal direction.

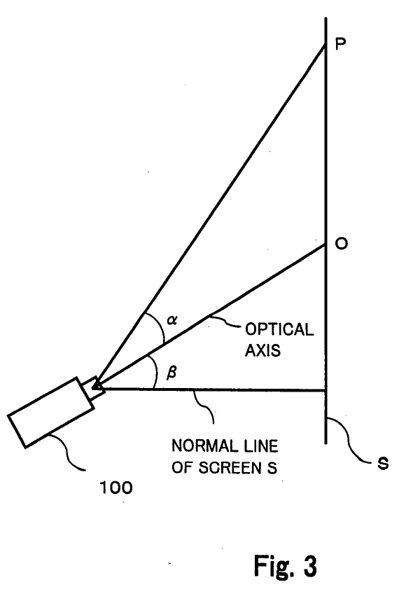

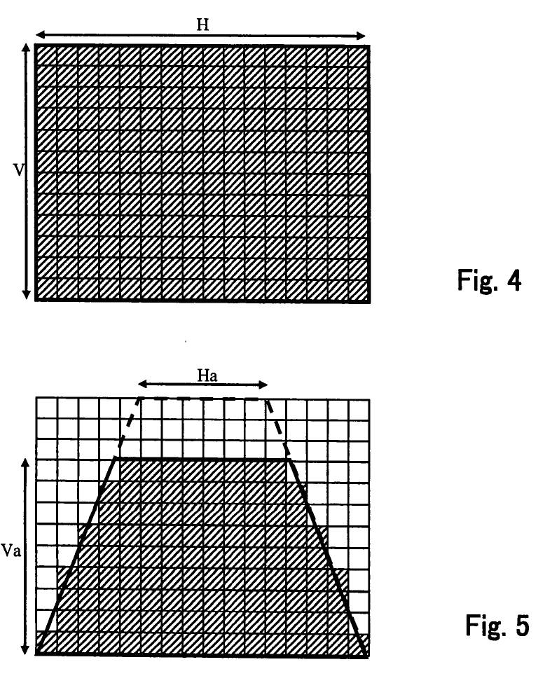

The parameter calculation section 11 calculates various parameters required for the reduction processing. This calculation of parameters will be described with reference to FIGS. 3 to 5. FIG. 3 is a view showing a projected state observed from a horizontal direction. In FIG. 3, an angle (hereinafter referred to as the projection angle) formed between the optical axis of the liquid crystal projector 100 and the normal line of the screen S is β, and an angle (hereinafter referred to as the lens angle) which is formed between a line drawn from the center of the projection lens 4 to an image center O on the screen S and a line drawn from the center of the projection lens 4 to a top end P of the image center is a. It is here assumed that there is no inclination in the horizontal direction. In other words, the projection of the optical axis of the projection lens 4 onto a plane including the normal line of the screen S is in agreement with the direction of the normal line of the screen S. FIG. 4 is a view showing a pixel array of the original image. In FIG. 4, the pixels indicated by hatch lines are effective pixels. The same is also applied to the other drawings showing a pixel array. As shown in FIG. 4, the number of pixels in the horizontal direction of the original image is indicated by H and the number of pixels in the vertical direction by V. FIG. 5 is a view showing a pixel array of a distortion corrected image to be formed by the trapezoid correction section 10. As shown in FIG. 5, the distortion corrected image has a substantially trapezoidal shape.

The parameter calculation section 11 calculates various parameters from the lens angle α, the projection angle β, the number of horizontal pixels H and the number of vertical pixels V according to a predetermined calculation formula. The parameters calculated in this embodiment include the number of effective pixels (hereinafter referred to as the number of corrected vertical pixels) Va corresponding to the height of a trapezoid of the distortion corrected image and the number of effective pixels (hereinafter referred to as the number of corrected horizontal pixels) Ha corresponding to the top side of the trapezoid of the distortion corrected image without considering the reduction in the vertical direction. The lens angle α, the number of horizontal pixels H and the number of vertical pixels V may be a fixed value or a variable value and are given to the parameter calculation section 11 by an appropriate means. The projection angle β may be input by the user but it is preferably detected by an angle sensor. The parameter calculation section 11 gives the number of horizontal pixels H, the number of vertical pixels V, the number of corrected vertical pixels Va and the number of corrected horizontal pixels Ha to the vertical reduction section 12 and the horizontal reduction section 13.

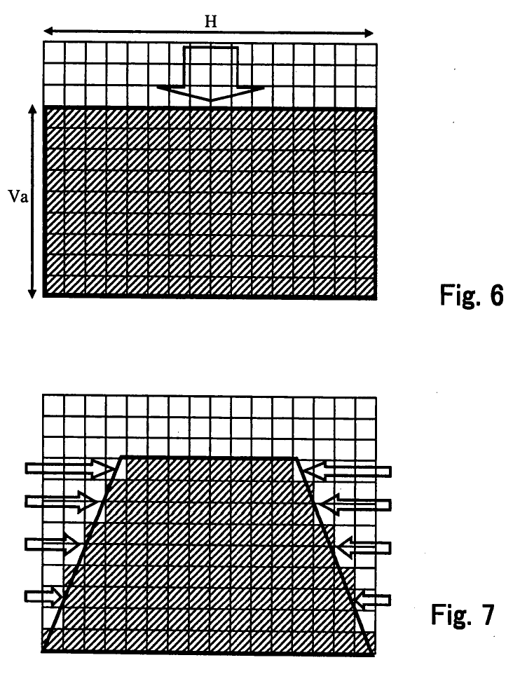

The vertical reduction section 12 uses the parameters received from the parameter calculation section 11 and reduces the original image in the vertical direction by pixel interpolation of generating one pixel from plural pixels. FIG. 6 is a view showing a state of processing to reduce the width of the image in the vertical direction. As shown in FIG. 6, a rectangular image having the number of vertical rows of effective pixels equal to the number of corrected vertical pixels Va is obtained by the processing to reduce in the vertical direction. The vertical reduction section 12 gives the image reduced in the vertical direction to the horizontal reduction section 13.

The horizontal reduction section 13 uses the parameters received from the parameter calculation section 11 to reduce the image received from the vertical reduction section 12 in the horizontal direction by pixel interpolation to produce one pixel from a plurality of pixels. FIG. 7 is a view showing a state of reduction processing in the horizontal direction. As shown in FIG. 7, a trapezoid-shaped distortion corrected image is obtained by the reduction processing in the horizontal direction. The horizontal reduction section 13 gives the obtained distortion corrected image to the outline correction section 20.

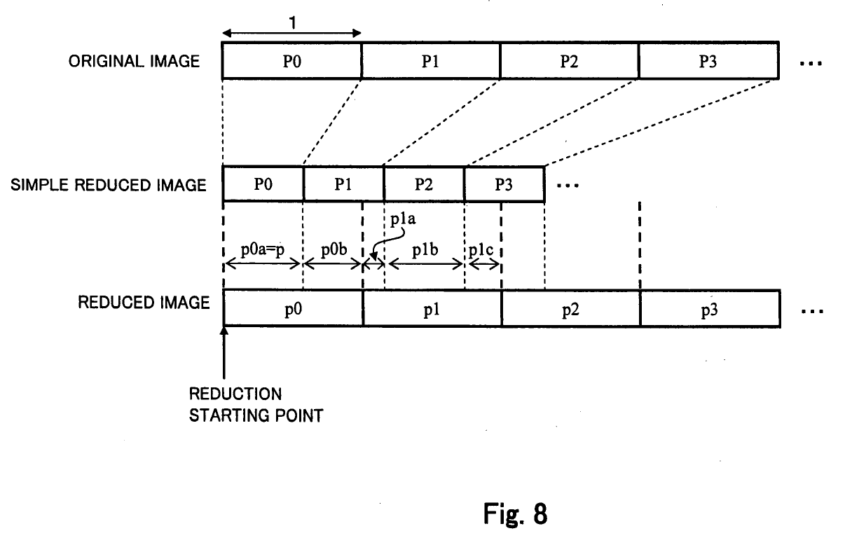

Here, the image reduction using the pixel interpolation for producing one pixel from a plurality of pixels will be described. The image reduction method by the pixel interpolation includes various algorithms and will be described here with reference to an average pixel method as an example. FIG. 8 is a view illustrating the concept of the average pixel method, showing a case that a certain line of the original image is reduced in the horizontal direction at a reduction ratio p. In FIG. 8, the line of the original image is formed with pixel values P0, P1, P2, P3, . . . arranged sequentially from a reduction starting point in the horizontal direction. Each pixel of the original image is assumed to have a length l in the horizontal direction. When this original image is simply reduced at the reduction ratio p without changing the number of pixels, a simple reduced image having the pixels with the length P in the horizontal direction arranged is obtained as shown in FIG. 8. In practice, however, the size of the pixels cannot be changed, so that the pixel value of each pixel of the reduced image is obtained by weighted mean processing of each pixel value of the simple reduced image which overlaps with the pertinent pixel. Here, a weight of the weighted mean of a certain pixel of the simple reduced image is the length of a portion of the pixel overlapping with those of the reduced image. Therefore, the pixel value p0 of the reduced image in FIG. 8 is expressed as p0=P0·p0a+P1·p0b, and the pixel value p1 is expressed as p1=P1·p1a+P2·p1b+P3·p1c. When specific numerals are substituted, such as the reduction ratio p=0.7 and the pixel value of the original image P0=0, P1=0, P2=1, P3=1 and P4=1, the pixel values of the reduced image become p0=0, p1=0.6, p2=1. Thus, when the image is reduced by the pixel interpolation for generating one pixel from plural pixels, the edge becomes dull and the outline becomes blurry. Therefore, the distortion corrected image obtained by the trapezoid correction section 10 has a blurred outline.

The outline correction section 20 performs an edge emphasis processing on the distortion corrected image received from the trapezoid correction section 10 to correct the outline. The structure of the outline correction section 20 it is not limited, as long as the outline correction section 20 can emphasize the edges in a distortion corrected image. A specific example structure is described below.

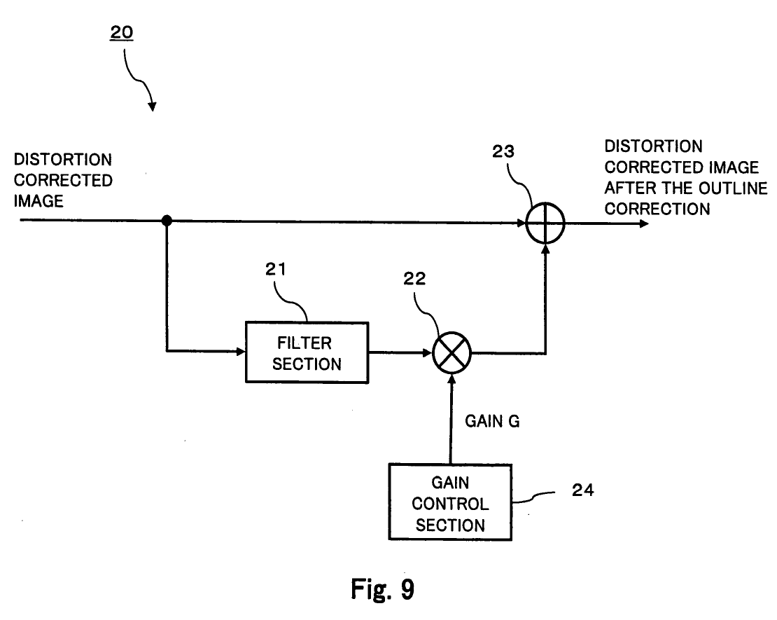

FIG. 9 is a block diagram showing an example structure of the outline correction section 20. This outline correction section 20 emphasizes the edge in the horizontal direction of the distortion corrected image. In FIG. 9, the outline correction section 20 has a filter section 21, a gain multiplication section 22, and an adder section 23.

The filter section 21 is a filter to extract the edge component in the horizontal direction from the input distortion corrected image and configured of, for example, a 5-tap FIR (finite impulse response) filter. The gain multiplication section 22 multiplies the edge component extracted by the filter section 21 by the gain G. The adder section 23 adds the edge component which is multiplied by the gain G by the gain multiplication section 22 to the original distortion corrected image.

Here, the gain G of the gain multiplication section 22 may be a fixed value but is preferably variable to enable varying the intensity of edge emphasis according to circumstances. For example, when the gain multiplication section 22 is configured such that the user can set the gain G, the user can change the intensity of the edge emphasis as desired to project an image having a desired appearance.

The gain G of the gain multiplication section 22 in this embodiment is controlled by a gain control section 24. The blur level of the outline of the distortion corrected image depends on the inclination of the projection direction of the image to the screen S, namely the inclination of the optical axis of the projection lens 4 to the screen S, and also depends on a zoom magnification m of the projection lens 4 if the projection lens 4 has a zoom function. Then, the gain control section 24 determines the gain G according to the inclination of the projection direction of the image to the screen S and the zoom magnification m. Here, the inclination of the projection direction of the image to the screen S is indicated by the angle and direction of the inclination of the optical axis of the projection lens 4 to the normal line to the screen S. In this embodiment, inclination of the projection direction of the image to the screen S is indicated by the projection angle β, and the gain control section 24 determines the gain G according to a correspondence table of (β, m) and the gain G. This table may be set in a design stage or may be set by the user.

Here, the gain G is determined according to the projection angle β and the zoom magnification m but may be determined according to one of them. Other than those parameters, one or more other parameters effecting the blur level of the outline of the distortion corrected image may be added.

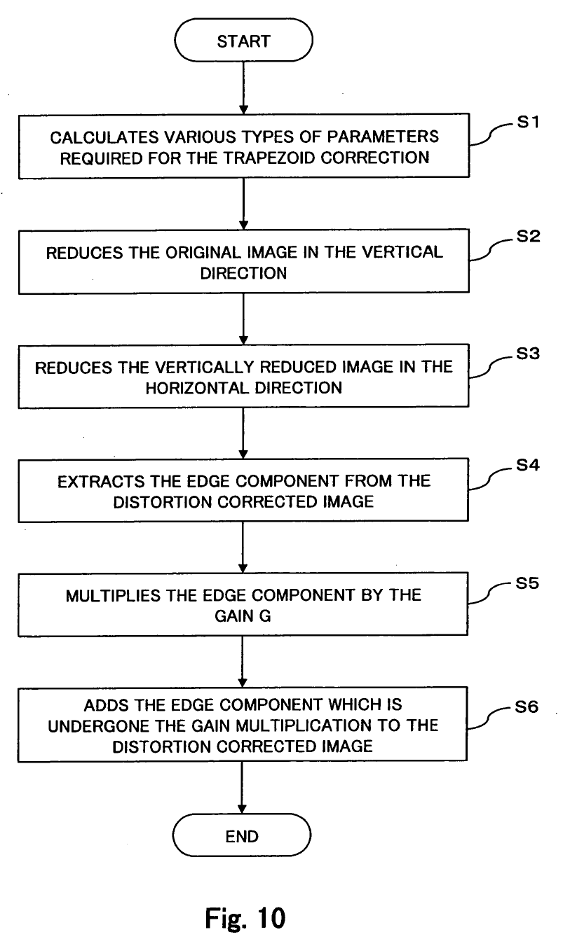

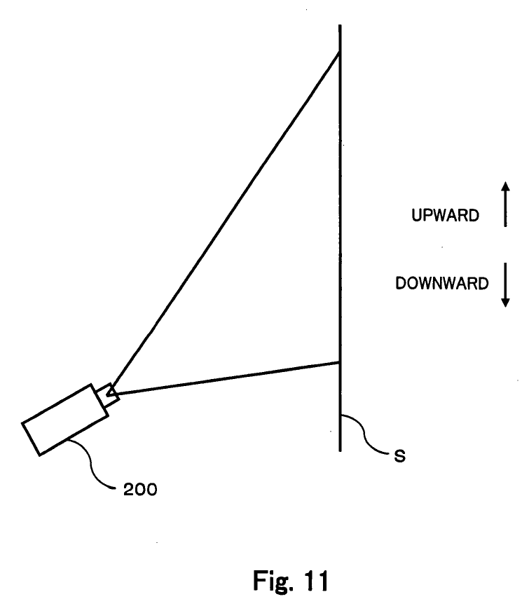

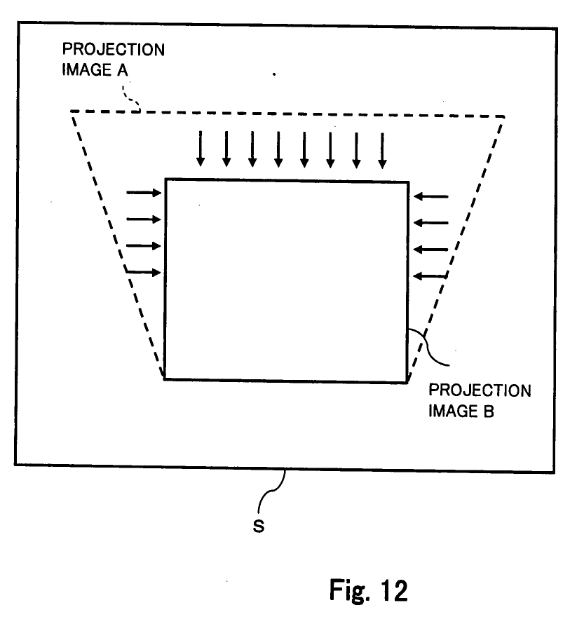

FIG. 10 is a flowchart showing an operation procedure of the image processing apparatus 1 according to this embodiment. The operation of the image processing apparatus 1 will be described with reference to FIG. 10.

First, the parameter calculation section 11 calculates various parameters required for the trapezoid correction and gives the calculated parameters to the vertical reduction section 12 and the horizontal reduction section 13 (S1). Then, the vertical reduction section 12 reduces the original image in the vertical direction (S2). The horizontal reduction section 13 reduces the image obtained by the vertical reduction section 12 in the horizontal direction to produce a distortion corrected image (S3).

The outline correction section 20 performs an edge emphasis processing on the formed distortion corrected image to correct the outline (S4 to S6). In this embodiment, the filter section 21 extracts the edge component in the horizontal direction from the distortion corrected image (S4). The gain multiplication section 22 multiplies the edge component extracted by the filter section 21 by the gain G supplied from the gain control section 24 (S5). The adder section 23 adds the edge component which is undergone the gain multiplication to the distortion corrected image received from the horizontal reduction section 13 (S6).

The distortion corrected image undergone the outline correction obtained by the adder section 23 is given to the liquid crystal panel 2 and displayed by the liquid crystal panel 2.

As described above, the outline correction is performed after the image reduction processing for correcting the trapezoid distortion in this embodiment, so that trapezoid correction can be performed without much blurring of the outline.

Because the gain G by which the edge component is multiplied in the outline correction is variable, the edge emphasis intensity can be varied depending on a positional relationship between the screen S and the liquid crystal projector 100, the zoom magnification and other conditions. Thus, it is possible to perform the appropriate outline correction depending on a situation.

Additionally, the gain G is varied according to the inclination of the optical axis or the zoom magnification of the projection lens 4 with respect to the screen S, so that the outline correction can be performed appropriately according to the inclination or the zoom magnification.

The present invention is not limited to the above-described embodiment, and various modifications may be made without deviating from the sprit and scope of the invention. For example, the projection display device is not limited to a liquid crystal projector, but may be another type of projector in which an image formed on the image forming section is magnified and projected.

The trapezoid correction section 10 of the above-described embodiment corresponds to the inclination in the vertical direction and may also correspond to both the inclinations in the vertical and horizontal directions. The trapezoid correction section 10 may perform the reduction in the vertical direction and the horizontal direction at the same time.

Although in the above-described embodiment, the edge emphasis is performed only in the horizontal direction, the invention may be configured such that edge emphasis is performed in both the horizontal direction and the vertical directions.

The outline correction section may also be disposed in the previous stage of the trapezoid correction section 10 to perform the edge emphasis processing on the original image prior to the trapezoid correction.

An inclination detection section, which detects the inclination of the projection direction of the image to the screen S, may also be provided. When the device is configured to include an inclination detection section, the trapezoid correction can be performed automatically if the results detected by the inclination detection section are provided to the trapezoid correction section 10. Additionally, when the detected result is provided to the gain control section 24, the gain can also be determined automatically.

1. An image processing apparatus used in a projection display device which displays an image formed on an image forming section by projecting it on a screen, for correcting the original image to correct a trapezoid distortion produced when the image is projected obliquely on the screen and forming the image to be formed on the image forming section, comprising:
a trapezoid correction section for correcting the trapezoid distortion by reducing the original image by pixel interpolation for producing one pixel from plural pixels; and
an outline correction section for performing an edge emphasis processing on the distortion corrected image obtained by the trapezoid correction section.

2. The image processing apparatus according to claim 1, wherein the outline correction section comprises:
a filter section for extracting an edge component of the distortion corrected image;
a gain multiplication section for multiplying the edge component extracted by the filter section by a gain; and
an adder section for adding the edge component multiplied by the gain by the gain multiplication section to the distortion corrected image.

3. The image processing apparatus according to claim 2, wherein the gain is variable.

4. The image processing apparatus according to claim 3, further comprising a gain control section for varying the gain according to at least one of an inclination of the projection direction of the image to the screen and a zoom magnification of a lens when the image is projected through the lens having a zoom function.

5. An image processing method used in a projection display device which displays an image formed on an image forming section by projecting it on a screen, for correcting the original image to correct a trapezoid distortion produced when the image is projected obliquely on the screen and forming the image to be formed on the image forming section, comprising:
a step of performing a trapezoid correction to correct the trapezoid distortion by reducing the original image by pixel interpolation for producing one pixel from plural pixels; and
a step of performing an outline correction to perform an edge emphasis processing on the distortion corrected image obtained by the trapezoid correction step.

6. An image processing program used in a projection display device which projects an image formed on an image forming section to display on a screen, for causing a computer to correct the original image to correct a trapezoid distortion produced when the image is projected obliquely on the screen and to form the image to be formed on the image forming section, comprising causing the computer to perform:
a step of performing a trapezoid correction to correct the trapezoid distortion by reducing the original image by pixel interpolation for producing one pixel from plural pixels; and
a step of performing an outline correction to perform an edge emphasis processing on the distortion corrected image obtained as a result of the trapezoid correction step.
